(19) United States
(12) Patent Application Publication
(10) Pub. No.: US 2015/0261435 A1
(43) Pub. Date: Sep. 17, 2015

(54) Measured Value Transducer with Internal Data Memory

(71) Applicant: Hottinger Baldwin Messtechnik GmbH, Darmstadt (DE)

(72) Inventors: Markus Haller, Weiterstadt (DE); Ulrich Kunkel, Dieburg (DE); Wolfgang Viel, Darmstadt (DE); Siegfried Wessler, Darmstadt (DE)

(21) Appl. No.: 14/416,808

(22) PCT Filed: Jul. 23, 2013
(86) PCT No.: PCT/DE2013/000399

§ 371 Date: May 18, 2015

(30) Foreign Application Priority Data
Jul. 23, 2012 (DE) 10 2012 014 584.5

(51) Int. Cl. G06F 3/06

(52) U.S. Cl. CPC G06F 3/061; G06F 3/068; G06F 3/065; G06F 3/0653

(57) ABSTRACT

The present invention relates to a measured value transducer (3) having an internal data memory (32), a processing apparatus (2) for such a measured value transducer (3), and a method for storing data in an internal data memory (32) of such a measured value transducer (3). The internal data memory (32) comprises a plurality of memory areas. A respective count value, which corresponds to a frequency of an occurrence of measured values in a certain measured value range, is respectively stored in at least two memory areas of the plurality of memory areas. Thereby, data relating to a loading of a measured value transducer can be stored directly in it and can later be directly and unambiguously allocated to it. Thereby a tamper-proof storage of the data is possible, and a producer or seller of the measured value transducer can determine whether it has been overloaded, in case that e.g. a complaint is made by an end user. In addition, conclusions about the measuring accuracy and/or the service life still to be expected of the measured value transducer are possible.

The present invention relates to a measured value transducer with an internal data memory, a processing apparatus for such a measured value transducer, and a method for storing data in the internal data memory of such a measured value transducer.

Measured value transducers with a data memory, in which characteristic values of the measured value transducer are stored, are known. For example, a measured value transducer with a data memory module is known from the DE 101 30 215 B4. In the data memory module, there can be stored characteristic values, as are otherwise recorded in a separate data sheet or a calibration protocol. If the measured value transducer is connected with an evaluation apparatus, then the characteristic values stored in the data memory module can be transmitted to the evaluation apparatus.

Furthermore, in the past efforts have been made to equip measured value transducers with a so-called Plug&Measure technology. This was to correspond with the so-called Plug&Play technology, with the aid of which computer accessories such as a mouse are connected to a computer. A standardized electronic data sheet for measured value transducers was developed, the so-called Transducer Electronic Data Sheet (TEDS) or electronic sensor data sheet. It is described in the IEEE 1451.4 standard and can be stored in an EEPROM of a measured value transducer. It can contain, for example, manufacturer data, model number, serial number, measurement range and sensitivity, as well as calibration data.

In the known measured value transducers with a data memory, respectively statistical data are stored in the data memory. They fulfill the same function as the characteristic values otherwise recorded in a separate data sheet, and thus enable an identification of the measured value transducer and its calibration. It is, however, not known to store, in such a data memory, also dynamic data such as process data of a measured value transducer.

In applications in which measured value transducer technology is utilized, there is partially the need for storing process data directly in a measured value transducer. This applies to the field of machine construction and similarly also for other technological fields.

The need for storing process data directly in a measured value transducer can exist for the manufacturer or producer of the measured value transducer or—if no direct distribution to end users takes place—for the seller or vendor thereof. An end user can also have such a need.

It is therefore the object of the invention to provide a measured value transducer with an internal data memory, a processing apparatus for such a measured value transducer, and a method for storing data in the internal data memory of such a measured value transducer, with which it is possible to store, directly in the measured value transducer, process data that arise during the running operation of the measured value transducer. It shall be possible to read out the data during the running operation and also after the dismounting and removal of the measured value transducer out of a measuring arrangement in which it is used.

This object is achieved with the method according to the claim 1, the processing apparatus according to the claim 6, the measured value transducer according to the claim 11, and the measuring system according to the claim 16.

According to a first embodiment of the invention, a method for storing data in an internal data memory of a measured value transducer is provided. The method encompasses a step of determining into which measured value range of a plurality of measured value ranges a measured value of the measured value transducer falls, a step of changing or varying, by a predetermined value, a count value corresponding to the determined measured value range, and a step of storing the changed or varied count value in a corresponding memory area of at least two memory areas of a plurality of memory areas of the internal data memory of the measured value transducer.

These steps can be carried out in the running process. Thereby, they make it possible to store, directly in the measured value transducer, process data, namely the count values, that arise in the running operation of the measured value transducer.

The count values stored in the internal data memory of the measured value transducer can be directly allocated to the measured value transducer and therewith to a user. Thereby, mistakes (of exchanging one for another) can no longer arise. No additional memory or storage possibilities outside of the measured value transducer, such as for example in an external subsequent or follow-up electronics circuit or a global database of a producer of the measured value transducer, are necessary. Thereby the effort or expense for such additional memory or storage possibilities can be saved. Moreover, the count values cannot be manipulated by the user, because the recording or writing of the count values in the internal data memory is only possible with the aid of a special functionality and the user has no access thereto.

According to a second embodiment of the invention based on the first embodiment, the method encompasses a step of reading out the count values stored in the at least two memory areas, and a step of transmitting the read-out count values to a processing apparatus.

The count values can be read out in the running process and also after the dismounting and removal of the measured value transducer out of a measuring arrangement in which it is used. As the case may be, the processing apparatus can belong to the measuring arrangement or can e.g. be a part of a testing or analysis arrangement. Thereby, both the user as well as the producer or a seller of the measured value transducer can read out the count values, and from an analysis thereof can for example make conclusions about the measuring accuracy and/or the service life still to be expected of the measured value transducer. Moreover, the producer or seller can judge, on the basis of the loading and especially overloading of the measured value transducer by the user, whether or not guarantee claims of the user based on a defect of the measured value transducer are justified.

According to a third embodiment of the invention based on one of the preceding embodiments, a first measured value range of the plurality of measured value ranges begins at a measured value that amounts to 50% of the permissible maximum measured value. Further measured value ranges of the plurality of measured value ranges respectively begin at a larger measured value than the first measured value range.

Not only measured values above the permissible maximum measured value, but also measured values that lie below it but nonetheless at the upper end of a total permissible measurement range, have a greater influence on the service life and the measuring accuracy of the measured value transducer, than measured values at the lower end or in the middle of the entire permissible measuring range. To also detect these can allow more-exact conclusions regarding the measuring accuracy and/or the service life still to be expected of the measured value transducer.

According to a fourth embodiment of the invention based on one of the preceding embodiments, at least five measured value ranges and corresponding memory areas are provided.

Through a finer gradation of the measured value ranges, the precision of conclusions about the measuring accuracy and/or service life still to be expected of the measured value transducer can be increased.

According to a fifth embodiment of the invention based on one of the preceding embodiments, a first measured value range of the plurality of measured value ranges begins at a measured value that amounts to 50% of the permissible maximum measured value. A second measured value range of the plurality of measured value ranges begins at a measured value that amounts to 75% of the permissible maximum measured value. A third measured value range of the plurality of measured value ranges begins at a measured value that amounts to 100% of the permissible maximum measured value. A fourth measured value range of the plurality of measured value ranges begins at a measured value that amounts to 110% of the permissible maximum measured value. A fifth measured value range of the plurality of measured value ranges begins at a measured value that amounts to 120% of the permissible maximum measured value. A sixth measured value range of the plurality of measured value ranges begins at a measured value that amounts to 130% of the permissible maximum measured value.

With this special configuration of the measured value ranges, especially exact conclusions about the measuring accuracy and/or service life still to be expected of the measured value transducer are possible.

According to a sixth embodiment of the invention, there is provided a processing apparatus for a measured value transducer with an internal data memory. The processing apparatus encompasses a processing device for processing an electrical measuring signal from the measured value transducer and producing a corresponding measured value, and a first transmission device for transmitting electrical signals. The processing device is adapted and configured to determine into which measured value range of a plurality of measured value ranges the measured value falls, to change or vary, by a predetermined value, a count value corresponding to a certain measured value range, and to store the changed count value in a corresponding memory area of at least two memory areas of a plurality of memory areas of the internal data memory of the measured value transducer. The first transmission device is adapted and configured to transmit the changed count value to the measured value transducer.

This makes it possible to store, directly in the measured value transducer, process data, namely the count values, that arise in the running operation of the measured value transducer. The count values stored in the internal data memory of the measured value transducer can be directly allocated to the measured value transducer and therewith to a user. Thereby, mistakes (of exchanging one for another) can no longer occur. No additional storage or memory possibilities outside of the measured value transducer, such as for example in an external subsequent or follow-up electronics circuit or a global database of a producer of the measured value transducer, are necessary. Thereby the extra effort or expense for such additional storage or memory possibilities can be saved. Moreover, the count values cannot be manipulated by the user, because the recording or writing of the count values in the internal data memory is only possible with the aid of a special functionality, and the user has no access thereto.

According to a seventh embodiment of the invention based on the sixth embodiment, the processing device is adapted and configured to read out the count values stored in the at least two memory areas. The first transmission device is adapted and configured to receive the count values that have been read out.

The count values can be read out in the running process and also after the dismounting and removal of the measured value transducer out of the measuring arrangement in which it is used. Thus, both the user as well as the producer or a seller of the measured value transducer can read out the count values and from an analysis thereof, for example make conclusions about the measuring accuracy and/or the service life still to be expected of the measured value transducer. The producer or seller can furthermore, in view of the loading and especially the overloading of the measured value transducer by the user, judge whether or not guarantee claims of the user due to a defect of the measured value transducer are justified.

According to an eighth embodiment of the invention based on the sixth or seventh embodiment, a first measured value range of the plurality of measured value ranges begins at a measured value that amounts to 50% of the permissible maximum measured value. Further measured value ranges of the plurality of measured value ranges respectively begin at a greater measured value than the first measured value range.

Not only measured values above the permissible maximum measured value, but also measured values that lie below it but nonetheless at the upper end of a total permissible measurement range, have a greater influence on the service life and the measuring accuracy of the measured value transducer, than measured values at the lower end or in the middle of the entire permissible measuring range. To also detect these can allow more-exact conclusions regarding the measuring accuracy and/or the service life still to be expected of the measured value transducer.

According to a ninth embodiment of the invention based on one of the sixth to eighth embodiments, at least five measured value ranges and corresponding memory areas are provided.

Through a finer gradation of the measured value ranges, the precision of conclusions about the measuring accuracy and/or service life still to be expected of the measured value transducer can be increased.

According to a tenth embodiment of the invention based on one of the sixth to ninth embodiments, a first measured value range of the plurality of measured value ranges begins at a measured value that amounts to 50% of the permissible maximum measured value. A second measured value range of the plurality of measured value ranges begins at a measured value that amounts to 75% of the permissible maximum measured value. A third measured value range of the plurality of measured value ranges begins at a measured value that amounts to 100% of the permissible maximum measured value. A fourth measured value range of the plurality of measured value ranges begins at a measured value that amounts to 110% of the permissible maximum measured value. A fifth measured value range of the plurality of measured value ranges begins at a measured value that amounts to 120% of the permissible maximum measured value. A sixth measured value range of the plurality of measured value ranges begins at a measured value that amounts to 130% of the permissible maximum measured value.

With this special configuration of the measured value ranges, especially exact conclusions about the measuring accuracy and/or service life still to be expected of the measured value transducer are possible.

According to an eleventh embodiment of the invention, a measured value transducer is provided. The measured value transducer encompasses a transducer device for producing an electrical measuring signal corresponding to a value of a physical quantity, and an internal data memory for storing data. The internal data memory comprises a plurality of memory areas and is adapted and configured to store, in at least two memory areas of the plurality of memory areas, respectively one count value that corresponds to the frequency of an occurrence of measured values in a certain measured value range.

This makes it possible to store, directly in the measured value transducer, process data, namely the count values, that arise in the running operation of the measured value transducer. The count values stored in the internal data memory of the measured value transducer can be directly allocated to the measured value transducer and therewith to a user. Thereby, mistakes (of exchanging one for another) can no longer occur. No additional storage or memory possibilities outside of the measured value transducer, such as for example in an external subsequent or follow-up electronics circuit or a global database of a producer of the measured value transducer, are necessary. Thereby the extra effort or expense for such additional storage or memory possibilities can be saved. Moreover, the count values cannot be manipulated by the user, because the recording or writing of the count values in the internal data memory is only possible with the aid of a special functionality, and the user has no access thereto.

According to a twelfth embodiment of the invention based on the eleventh embodiment, the measured value transducer encompasses a second transmission device for transmitting electrical signals, which is adapted and configured to transmit, to a processing apparatus, the count values stored in the at least two memory areas.

The count values can be read out in the running process and also after the dismounting and removal of the measured value transducer out of the measuring arrangement in which it is used. Thus, both the user as well as the producer or a seller of the measured value transducer can read out the count values and from an analysis thereof, for example make conclusions about the measuring accuracy and/or the service life still to be expected of the measured value transducer. The producer or seller can furthermore, in view of the loading and especially the overloading of the measured value transducer by the user, judge whether or not guarantee claims of the user due to a defect of the measured value transducer are justified.

According to a thirteenth embodiment of the invention based on the eleventh or twelfth embodiment, a first measured value range of the plurality of measured value ranges begins at a measured value that amounts to 50% of the permissible maximum measured value. Further measured value ranges of the plurality of measured value ranges respectively begin at a greater measured value than the first measured value range.

Not only measured values above the permissible maximum measured value, but also measured values that lie below it but nonetheless at the upper end of a total permissible measurement range, have a greater influence on the service life and the measuring accuracy of the measured value transducer, than measured values at the lower end or in the middle of the entire permissible measuring range. To also detect these can allow more-exact conclusions regarding the measuring accuracy and/or the service life still to be expected of the measured value transducer.

According to a fourteenth embodiment of the invention based on one of the eleventh to thirteenth embodiments, at least five measured value ranges and corresponding memory areas are provided.

Through a finer gradation of the measured value ranges, the precision of conclusions about the measuring accuracy and/or service life still to be expected of the measured value transducer can be increased.

According to a fifteenth embodiment of the invention based on one of the eleventh to fourteenth embodiments, a first measured value range of the plurality of measured value ranges begins at a measured value that amounts to 50% of the permissible maximum measured value. A second measured value range of the plurality of measured value ranges begins at a measured value that amounts to 75% of the permissible maximum measured value. A third measured value range of the plurality of measured value ranges begins at a measured value that amounts to 100% of the permissible maximum measured value. A fourth measured value range of the plurality of measured value ranges begins at a measured value that amounts to 110% of the permissible maximum measured value. A fifth measured value range of the plurality of measured value ranges begins at a measured value that amounts to 120% of the permissible maximum measured value. A sixth measured value range of the plurality of measured value ranges begins at a measured value that amounts to 130% of the permissible maximum measured value.

With this special configuration of the measured value ranges, especially exact conclusions about the measuring accuracy and/or service life still to be expected of the measured value transducer are possible.

According to a sixteenth embodiment of the invention, there is provided a measuring system with a processing apparatus according to one of the sixth to tenth embodiments and a measuring transducer according to one of the eleventh to fifteenth embodiments, whereby a method according to one of the first to fifth embodiments serves for accessing the internal data memory of the measured value transducer.

The advantages already described above in connection with its components, can be achieved with the measuring system.

The invention will be explained in further detail in the following on the basis of an example embodiment in connection with a schematic drawing. It is shown by:

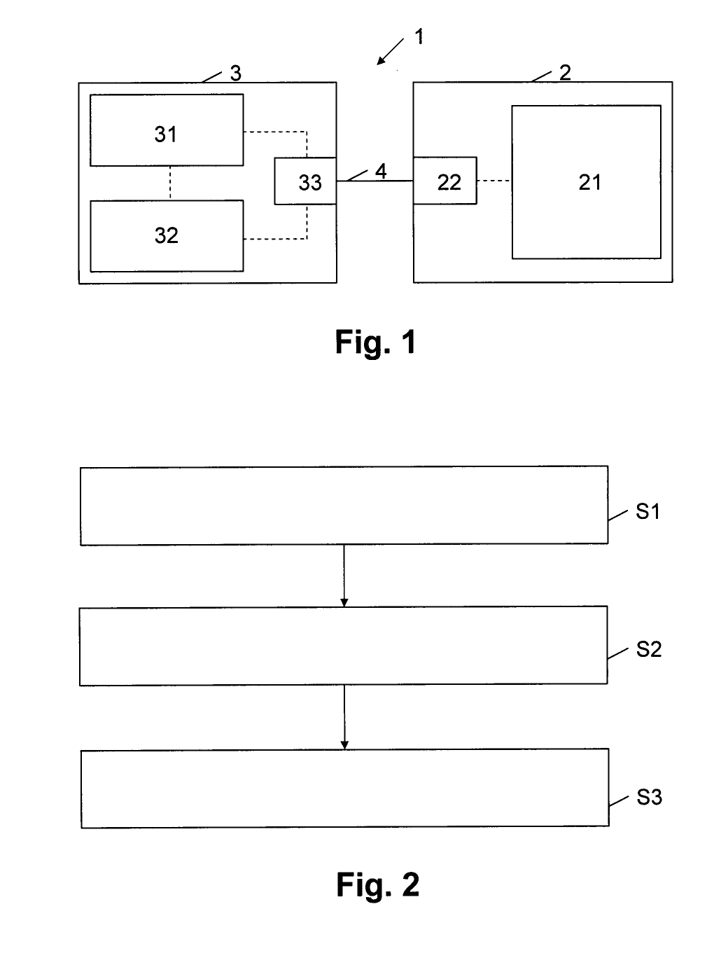

FIG. 1 a block circuit diagram of an exemplary measuring system; and

FIG. 2 a flow diagram which illustrates the basic or fundamental steps of an exemplary method for storing data in an internal data memory of a measured value transducer.

The FIG. 1 shows a block circuit diagram of an exemplary measuring system 1. This encompasses a processing apparatus 2 and a measured value transducer 3 also designated as a sensor, which are connected with one another via a connection 4. The processing apparatus 2 comprises a processing device 21 and a first transmission device 22, while the measured value transducer 3 comprises a transducer device 31, an internal data memory 32 and a second transmission device 33.

The processing apparatus 2 can, for example, involve a measuring amplifier, a computer or a different subsequent or follow-up electronics circuit. Depending on how the processing apparatus 2 is embodied, the processing device 21 and the first transmission device 22 can be integrated or discrete elements. For example, they can both be realized as a component of an integrated circuit of a measuring amplifier. Depending on how the processing device 21 and the first transmission device 22 are realized, the connection between them, which is symbolically illustrated in FIG. 1, can be present as a further element or not.

The measured value transducer 3 can be a passive measured value transducer, that is to say a measured value transducer without signal amplification. For example, it can be a force transducer, a torque transducer, a pressure transducer, a displacement transducer, a strain transducer, a temperature transducer, a moisture transducer or any other desired transducer. Depending on what measured value is to be detected, its transducer device 31 detects or acquires the desired measured value based on a physical or chemical effect and transforms it into a further processible value, whereby in this case this involves an electrical measuring signal. The transducer device 31 can, for example, utilize strain gages for transforming the measured value into an electrical signal. In that regard, the strain gages can be integrated into a Wheatstone bridge configured as a full bridge, a half bridge, or a quarter bridge. For example, the measured value transducer 3 can be a pressure transducer and its transducer device 31 can be provided with a strain gage circuit-connected as a full bridge.

The internal data memory 32 and the second transmission device 33 of the measured value transducer 3 can be separate elements or can be integrated with one another and/or with the transducer device 31. Depending on how the transducer device 31, the internal data memory 32 and the second transmission device 33 are realized, the connections between them, illustrated symbolically in FIG. 1, can be present as further elements or not.

Regarding the internal data memory 32, this can involve a memory already present anyway in the measured value transducer 3, or a specially provided memory. In the former case, for example, an electronic data sheet according to the IEEE 1451.4 standard or an EEPROM or another memory medium, in which this is stored, can be used as the internal data memory 32. In other words, the internal data memory 32 can be a TEDS or the memory medium in which it is stored.

Various different connectors or terminals come into consideration as the connection 4. If the transducer device 31 is strain gage based, then the transducer device 31 or the measured value transducer 3 can, for example, be connected in 6-conductor technology and therefore the connection 4 can be embodied as a cable with six conductors. A connection in 3-conductor or 4-conductor technology is also possible.

During a measuring operation, respectively an electrical measuring signal, which corresponds to a value of a measured value or quantity detected by the transducer device 31, is transmitted via the second transmission device 33 and the connection 4 to the first transmission device 22 of the processing apparatus 2. The processing device 21 of the processing apparatus 2 processes the electrical measuring signal received from the first transmission device 22 and produces a corresponding measured value. The processing can encompass an amplification of the electrical measuring signal.

Thereupon the processing device 21 determines into which measured value range of a plurality of measured value ranges the produced measured value falls, and changes, by a predetermined value, a count value corresponding to the determined measured value range. For example, the count value can be increased or decreased by one or a different value. In that regard, an initial starting value of the count value can be freely selected. If the count value is increased, then its initial starting value can be set to zero, for example. If the count value is decreased, then its initial starting value can, for example, be set in such a manner so that the count value upon being reduced to zero provides a stopping point for an expected end of the service life of the measured value transducer 3.

The changed count value is transmitted via the first transmission device 22 and the connection 4 to the second transmission device 33 and is stored in a corresponding memory area of the internal data memory 32 of the measured value transducer 3. In that regard, at least two measured value ranges and corresponding memory areas of the internal data memory 32 are provided for storing the count values. The internal data memory 32 can furthermore also comprise additional memory areas for other purposes.

Thus, respectively a frequency of an occurrence of measured values in a certain measured value range is stored in a corresponding memory area of the internal data memory 32. In other words, loading collectives or collective informations about loading are stored directly in the measured value transducer 3, and not in an external memory medium. In that regard, the measured value transducer 3 can be a passive measured value transducer, that is to say a measured value transducer without signal amplification and electronics provided therefor.

The above described functionality can be provided already during the production of the processing apparatus 2. It may, however, also be retrofitted at a later time point. For example, it can be realized via a corresponding functionality in a firmware of the processing apparatus 2, whereby this firmware can be loaded in also at a later time point and thereby the functionality can be retro-fitted. In that regard, for example, the firmware can be stored in an EEPROM (not shown in FIG. 1) of the processing apparatus 2.

The measured value ranges and the corresponding memory areas of the internal data memory 32 are, in principle, freely selectable. Of particular interest are measured value ranges that lie below a permissible maximum measured value but are nonetheless at the upper end of a total permissible measuring range, and measured value ranges above the permissible maximum measured value. Measured values falling into such measured value ranges have a greater influence on the service life and the measuring accuracy of the measured value transducer 3, than measured values at the lower end or in the middle of the total permissible measuring range. Exemplary configurations present themselves as follows.

In a first configuration a first measured value range begins at a measured value that amounts to 50%, 55%, 60%, 65%, 70%, 75%, 80%, 85%, 90% or 95% of the permissible maximum measured value. A second measured value range begins at a measured value that amounts to 100% of the permissible maximum measured value. The first measured value range can extend to the beginning of the second measured value range, or not extend to it, or continue past it.

In a second configuration, a first measured value range begins at a measured value that amounts to 85% of the permissible maximum measured value. A second measured value range begins at a measured value that amounts to 100% of the permissible maximum measured value. A third measured value range begins at a measured value that amounts to 115% of the permissible maximum measured value. The first measured value range can extend to the beginning of the second measured value range, or not extend to it, or continue past it. The second measured value range can extend to the beginning of the third measured value range, or not extend to it, or continue past it.

In a third configuration, a first measured value range begins at a measured value that amounts to 90% of the permissible maximum measured value. A second measured value range begins at a measured value that amounts to 100% of the permissible maximum measured value. A third measured value range begins at a measured value that amounts to 110% of the permissible maximum measured value. A fourth measured value range begins at a measured value that amounts to 120% of the permissible maximum measured value. A fifth measured value range begins at a measured value that amounts to 130% of the permissible maximum measured value. Each one of the measured value ranges can extend to the beginning of the next successive measured value range, or not extend to it, or continue past it.

Numerous further configurations are conceivable. Thus, for example, larger measured value ranges can be used. For example, a first measured value range can begin at a measured value that amounts to 75% of the permissible maximum measured value, a second measured value range can begin at a measured value that amounts to 100% of the permissible maximum measured value, and a third measured value range can begin at a measured value that amounts to 125% of the permissible maximum measured value. Or a first measured value range can begin at a measured value that amounts to 100% of the permissible maximum measured value, a second measured value range can begin at a measured value that amounts to 150% of the permissible maximum measured value, and a third measured value range can begin at a measured value that amounts to 200% of the permissible maximum measured value.

However, also smaller measured value ranges can be used. For example, a first measured value range can begin at a measured value that amounts to 85% of the permissible maximum measured value, a second measured value range can begin at a measured value that amounts to 90% of the permissible maximum measured value, a third measured value range can begin at a measured value that amounts to 95% of the permissible maximum measured value, a fourth measured value range can begin at a measured value that amounts to 100% of the permissible maximum measured value, a fifth measured value range can begin at a measured value that amounts to 105% of the permissible maximum measured value, a sixth measured value range can begin at a measured value that amounts to 110% of the permissible maximum measured value, a seventh measured value range can begin at a measured value that amounts to 115% of the permissible maximum measured value, etc.

Moreover, measured value ranges can be used, which do not all have the same size. Thus, for example, a first measured value range can begin at a measured value that amounts to 50% of the permissible maximum measured value, a second measured value range can begin at a measured value that amounts to 75% of the permissible maximum measured value, a third measured value range can begin at a measured value that amounts to 100% of the permissible maximum measured value, a fourth measured value range can begin at a measured value that amounts to 110% of the permissible maximum measured value, a fifth measured value range can begin at a measured value that amounts to 120% of the permissible maximum measured value, and a sixth measured value range can begin at a measured value that amounts to 130% of the permissible maximum measured value. Moreover, a first measured value range can begin already at a smaller measured value, such as e.g. a measured value that amounts to 10% of the permissible maximum measured value, and thereby, for example, also the entire permissible measuring range can be covered.

Any desired sub-combinations of the abovementioned measured value ranges or other measured value ranges are conceivable. The measured value ranges can also begin at values that are not explicitly mentioned, such as e.g. a measured value that amounts to 91% of the permissible maximum measured value, a measured value that amounts to 102% of the permissible maximum measured value, a measured value that amounts to 108% of the permissible maximum measured value, a measured value that amounts to 133% of the permissible maximum measured value, a measured value that amounts to 220% of the permissible maximum measured value, etc.

In the various configurations, respectively each one of the measured value ranges can extend to the beginning of the next successive measured value range, or not extend to it, or continue past it. The selection of a suitable or fitting configuration can be carried out under consideration of measured values to be expected in a particular application. It is, in principle, only limited by the size of the internal data memory 32 or the size of the total memory area of the internal data memory 32 available for storage of count values.

The count values stored in the various different memory areas of the internal data memory 32 can be read out individually or in total as needed. This can take place during the running operation of the measured value transducer 3 by a user thereof. In this case, the count values can be transmitted via the second transmission device 33 and the connection 4 to the first transmission device 22, whereby the read-out can be carried out by the processing device 21. In that regard, the transmission of the count values can take place via conductors of the connection 4 that are also used for a transmission of electrical measuring signals. The user can analyze the count values that have been read out, whereby the analysis results can make it possible, for example, to reach conclusions about the measuring accuracy and/or the service life still to be expected of the measured value transducer 3.

Generally, the writing or recording of count values or other data into the internal data memory 32 of the measured value transducer 3, and the reading of count values or other data out of it, or the transmission of these count values or other data, can be realized by means of various different transmission technologies. Thus, in that regard, an additional conductor (“zero wire”) in the cable of the connection 4 can be omitted. However, the transmission can also take place by means of such an additional conductor in the cable (“one wire”) or wirelessly (“no wire”). The latter can be implemented, for example, with the aid of RFID technology (“radio frequency identification” or “identification with aid of electromagnetic waves”).

The count values stored in the various different memory areas of the internal data memory 32 can also be read out after the dismounting and removal of the measured value transducer 3 out of a measuring arrangement in which it is used. For example, the count values can be read out by a producer or seller of the measured value transducer 3 with the aid of a corresponding subsequent or follow-up electronics circuit, which may be e.g. a part of a testing or analysis arrangement. The producer or seller can then analyze the read-out count values, in order to determine, for example, to what extent the measured value transducer 3 has been loaded by its user. For example, it can be determined whether the permissible maximum measured value has been reached or exceeded, how often this occurred, and in what magnitude range the over-limit excursions fell.

If the producer or seller knows the loading and especially the overloading of the measured value transducer 3 by the user, then on the basis of this knowledge he can, for example, judge whether or not guarantee claims of the user due to a defect of the measured value transducer 3 are justified. If the permissible maximum measured value was exceeded, then guarantee claims could be rejected.

A different possible application exists in estimating the measuring accuracy and/or the service life that is still to be expected of the measured value transducer 3. This could e.g. also be carried out on a routine basis at certain time intervals, that is to say a regular maintenance of the measured value transducer 3 could be carried out by the producer or seller. Because loading frequencies and not individual measured values are stored in the measured value transducer 3, a storage of loading data over a long time period such as e.g. 5 or 10 years is possible even with a limited storage space. Such a long time storage can, for example, help in a longterm quality control.

For connecting the processing apparatus 2 with a control system not shown in FIG. 1, various different bus systems can be utilized. Thus, for example, the Profibus-DP (“Decentralized Peripherals”), the CAN-Bus (“Controller Area Network”) or a different field bus can be utilized. In that regard, the writing or recording of data in the internal data memory 32 of the measured value transducer 3 and the reading of data out of it can take place via various different access methods and mechanisms. Thus, for example, with the Profibus-DP the DP-V1-functionality (acyclical data exchange) or DP-V2-functionality (isochronous data exchange) can be utilized, and with the CAN-Bus the SDO-functionality (Service Data Objects) from the communication protocol CANopen based on CAN.

The FIG. 2 shows a flow diagram that illustrates the basic or fundamental steps of an exemplary method for storing data in the internal data memory 32 of the measured value transducer 3. In a step S1 it is determined into which measured value range of a plurality of measured value ranges, a measured value of the measured value transducer 3 falls. In a step S2 a count value corresponding to the determined measured value range is changed by a predetermined value. In a step S3, the changed count value is stored in a corresponding memory area of at least two memory areas of a plurality of memory areas of the internal data memory 32 of the measured value transducer 3.

The method can encompass further steps not shown in FIG. 2, such as e.g. a step of reading out the count values stored in the at least two memory areas, and a step of transmitting the read-out count values to a processing apparatus.

All of these steps can be carried out during the running process, that is to say during the measuring operation. The use of the stored count values, on the other hand, usually takes place outside of the running process, e.g. during service or management.

The count values stored in the internal data memory 32 of the measured value transducer 3 can be directly allocated to the measured value transducer 3 and therewith to the respective user. Thereby, mistakes (of exchanging one for another) can no longer arise. No additional memory or storage possibilities outside of the measured value transducer, such as for example in an external subsequent or follow-up electronics circuit or a global database of the producer, are necessary. Thus the effort or expense for such additional memory or storage possibilities can be saved. Moreover, the count values cannot be manipulated by the user, because the recording or writing of count values into the internal data memory 32 is only possible with the aid of the above described special functionality in the subsequent or follow-up electronics circuit and the user has no access thereto.

In summary, the present invention relates to a measured value transducer 3 with an internal data memory 32, a processing apparatus 2 for such a measured value transducer 3, and a method for storing data in an internal data memory 32 of such a measured value transducer 3. The internal data memory 32 comprises a plurality of memory areas. In at least two memory areas of the plurality of memory areas, respectively a count value, which corresponds to a frequency of an occurrence of measured values in a certain measured value range, is stored. Thus, data relating to a loading of a measured value transducer can be stored directly in it, and later can be directly and unambiguously allocated to it. Thereby a tamper-proof or manipulation-secure storage of data is possible, and a producer or seller of the measured value transducer can determine whether it has been overloaded, if e.g. a complaint has been made by an end user. Additionally, conclusions are possible about the measuring accuracy and/or the service life still to be expected of the measured value transducer.

1. Method for storing data in an internal data memory (32) of a measured value transducer (3), with the steps:
determining (S1) into which measured value range of a plurality of measured value ranges, a measured value of the measured value transducer (3) falls;
changing (S2), by a predetermined value, a count value corresponding to the determined measured value range; and
storing (S3) the changed count value in a corresponding memory area of at least two memory areas of a plurality of memory areas of the internal data memory (32) of the measured value transducer (3).

2. Method according to claim 1, with the steps:
reading out the count values stored in the at least two memory areas; and
transmitting the read-out count values to a processing apparatus (2).

3. Method according to claim 1, wherein
a first measured value range of the plurality of measured value ranges begins at a measured value that amounts to 50%; of a permissible maximum measured value, and further measured value ranges of the plurality of measured value ranges respectively begin at a larger measured value than the first measured value range.

4. Method according to claim 1, wherein
at least five of the measured value ranges and a corresponding number of the memory areas are provided.

5. Method according to claim 1, wherein
a first measured value range of the plurality of measured value ranges begins at a measured value that amounts to 50% of a permissible maximum measured value, a second measured value range of the plurality of measured value ranges begins at a measured value that amounts to 75% of the permissible maximum measured value, a third measured value range of the plurality of measured value ranges begins at a measured value that amounts to 100% of the permissible maximum measured value, a fourth measured value range of the plurality of measured value ranges begins at a measured value that amounts to 110% of the permissible maximum measured value, a fifth measured value range of the plurality of measured value ranges begins at a measured value that amounts to 120% of the permissible maximum measured value, and a sixth measured value range of the plurality of measured value ranges begins at a measured value that amounts to 130% of the permissible maximum measured value.

6. Processing apparatus (2) for a measured value transducer (3) with an internal data memory (32), having:
a processing device (21) adapted and configured to process an electrical measuring signal from the measured value transducer (3) and to produce a corresponding measured value; and
a first transmission device (22) adapted and configured to transmit electrical signals, wherein
the processing device (21) is adapted and configured to determine into which measured value range of a plurality of measured value ranges the measured value falls, to change, by a predetermined value, a count value corresponding to the determined measured value range, and to store the changed count value in a corresponding memory area of at least two memory areas of a plurality of memory areas of the internal data memory (32) of the measured value transducer (3), and
the first transmission device (22) is adapted and configured to transmit the changed count value to the measured value transducer (3).

7. Processing apparatus (2) according to claim 6, wherein
the processing device (21) is adapted and configured to read out the count values stored in the at least two memory areas, and
the first transmission device (22) is adapted and configured to receive the read-out count values.

8. Processing apparatus (2) according to claim 6, wherein
a first measured value range of the plurality of measured value ranges begins at a measured value that amounts to 50% of a permissible maximum measured value, and further measured value ranges of the plurality of measured value ranges respectively begin at a larger measured value than the first measured value range.

9. Processing apparatus (2) according to claim 6, wherein
at least five of the measured value ranges and a corresponding number of the memory areas are provided.

10. Processing apparatus (2) according to claim 6, wherein
a first measured value range of the plurality of measured value ranges begins at a measured value that amounts to 50% of a permissible maximum measured value, a second measured value range of the plurality of measured value ranges begins at a measured value that amounts to 75% of the permissible maximum measured value, a third measured value range of the plurality of measured value ranges begins at a measured value that amounts to 100% of the permissible maximum measured value, a fourth measured value range of the plurality of measured value ranges begins at a measured value that amounts to 110% of the permissible maximum measured value, a fifth measured value range of the plurality of measured value ranges begins at a measured value that amounts to 120% of the permissible maximum measured value, and a sixth measured value range of the plurality of measured value ranges begins at a measured value that amounts to 130% of the permissible maximum measured value.

11. Measured value transducer (3) having:
a transducer device (31) adapted and configured to produce an electrical measuring signal corresponding to a value of a physical quantity; and
an internal data memory (32) adapted and configured to store data,
wherein the internal data memory (32) comprises a plurality of memory areas and is adapted and configured to store, in at least two memory areas of the plurality of memory areas, respectively a count value that corresponds to a frequency of an occurrence of measured values in a certain measured value range.

12. Measured value transducer (3) according to claim 11, having:
a second transmission device (33) adapted and configured to transmit electrical signals, which is adapted and configured to transmit, to a processing apparatus (2), the count values that are stored in the at least two memory areas.

13. Measured value transducer (3) according to claim 11, wherein
a first measured value range of the plurality of measured value ranges begins at a measured value that amounts to 50% of a permissible maximum measured value, and further measured value ranges of the plurality of measured value ranges respectively begin at a larger measured value than the first measured value range.

14. Measured value transducer (3) according to claim 11, wherein
at least five of the measured value ranges and a corresponding number of the memory areas are provided.

15. Measured value transducer (3) according to claim 11, wherein
a first measured value range of the plurality of measured value ranges begins at a measured value that amounts to 50% of a permissible maximum measured value, a second measured value range of the plurality of measured value ranges begins at a measured value that amounts to 75% of the permissible maximum measured value, a third measured value range of the plurality of measured value ranges begins at a measured value that amounts to 100% of the permissible maximum measured value, a fourth measured value range of the plurality of measured value ranges begins at a measured value that amounts to 110% of the permissible maximum measured value, a fifth measured value range of the plurality of measured value ranges begins at a measured value that amounts to 120% of the permissible maximum measured value, and a sixth measured value range of the plurality of measured value ranges begins at a measured value that amounts to 130% of the permissible maximum measured value.

16. Measuring system (1) for performing the method according to claim 1, wherein the measuring system comprises a processing apparatus (2) and a measured value transducer (3),
wherein the measured value transducer comprises a transducer device (31) adapted and configured to produce an electrical measuring signal corresponding to a value of a physical quantity; and
an internal data memory (32) adapted and configured to store data,
wherein the internal data memory (32) comprises a plurality of memory areas and is adapted and configured to store, in at least two memory areas of the plurality of memory areas, respectively a count value that corresponds to a frequency of an occurrence of measured values in a certain measured value range;
wherein the processing apparatus comprises a processing device (21) adapted and configured to process the electrical measuring signal from the measured value transducer (3) and to produce a corresponding measured value; and
a first transmission device (22) adapted and configured to transmit electrical signals, wherein
the processing device (21) is adapted and configured to perform the method by said determining into which measured value range of the plurality of measured value ranges the measured value falls, said changing, by the predetermined value, of the count value corresponding to the determined measured value range, and said storing of the changed count value in the corresponding memory area of the at least two memory areas of the plurality of memory areas of the internal data memory (32) of the measured value transducer (3), and
the first transmission device (22) is adapted and configured to transmit the changed count value to the measured value transducer (3).
